(19) United States
(12) Patent Application Publication
(10) Pub. No.: US 2004/0264372 A1
(43) Pub. Date: Dec. 30, 2004

(54) Quality of service (QoS) routing for Bluetooth personal area network (PAN) with inter-layer optimization

(75) Inventor: Leping Huang, Tokyo (JP)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/608,237

(22) Filed: Jun. 27, 2003

(51) Int. Cl. H04L 12/28

(52) U.S. Cl. 370/230; 370/310

(57) ABSTRACT

This invention grows out of an appreciation by the inventor that the QoS is an important metric for a Bluetooth (BT) PAN, as unpredictable indoor radio conditions can degrade the QoS and the stability of the routing protocol that is used to guarantee the QoS. In a first aspect this invention provides a traffic measurement embodiment that updates the QoS information in all nodes along the path of a packet. This embodiment functions to monitor the end-to-end QoS quality, and improves the protocol stability. In a second aspect this invention provides a cross-layer optimization embodiment by which the BT Link layer information (e.g., LinkSupervision_Timeout and RSSI) is integrated into the PAN routing protocol, to further enhance the stability of the routing protocol.

### TECHNICAL FIELD

This invention relates generally to wireless communications systems and networks and, more specifically, relates to the connectivity of mobile nodes in a wireless personal area network (PAN), such as one based on a low power RF system known as Bluetooth™ (BLUETOOTH is a Trademark owned by Bluetooth SIG, Inc.).

### BACKGROUND

The Bluetooth™ (BT) protocol has resulted from the National Telecommunications Act opening new public access to the ultra high frequency (UHF) and very high frequency (VHF) bands. As a direct consequence, wireless local area networking is rapidly evolving as the communications standard for small and mobile corporations and other organizations. An important aspect of these new wireless networks is the integration of household (and business office) appliances, laptop computers, and personal communications service (PCS) devices. This technology, called BT, seamlessly connects each intelligent appliance in a household or an office within a “piconet” (implying a very small) wireless network.

BT is an embedded, low-power, short-range, radio-frequency (RF) technology, although it can also be IR media-based with moderate bandwidth. BT is particularly attractive for exchanging data between personal devices such as cellular phones, radios, pagers, personal digital assistants, notebook computers, video and still cameras, audio players, and local area networks (LANs).

With an operating range of 10 meters or less, the reach of BT exceeds the current range of IR, but falls far short of other types of wireless networks. BT is implemented at 2.4 GHz in the Industrial, Scientific, and Medical (ISM) band.

The BT architecture integrates a combination of hardware and software into the networking device. The hardware is an embeddable module, or a module residing on a card, which interfaces with the host device. It interfaces on one side with the host and on the other side with another BT device via its RF or IR transceiver. On the host side, there are four currently identified interfaces: the universal serial bus (USB), the PC card (or PCMCIA), and two serial interfaces, UART and RS232. All of these have established standards that define the physical and logical interaction. However, the higher level interaction between the BT device and the host is defined in unique BT protocols and packets.

As can be seen in FIG. 1, the software includes salutation and security managers, a database, and the protocol stack. The transport technology is digital packet-oriented communications (rather than analog or streaming digital). Communication with the host includes hardware control and event monitor packet types. Asynchronous connection-oriented (ACO) and synchronous connection-oriented (SCO) packets are used for the link communication between devices, with SCO used primarily for real-time audio and video. Conventional packets, such as the Telephony Communications Service (TCS) and Internet Protocol (IP), are encapsulated in the BT SCO and ACO data packets, adding one more layer to the stack and therefore one more encapsulation with its overhead. Therefore, BT requires an additional protocol stack for a PC. FIG. 1 also presents an example of the required additional protocol stack. The IrDa Object Exchange (OBEX) is required for IR interoperability. Also shown is a wireless network connection to a BT device that transfers data using a User Datagram Protocol (UDP) or a Transmission Control Protocol (TCP).

Protocols, stacks, and the salutation manager provide BT “services”. The salutation manager provides both server advertisement and client request capabilities, in addition to the brokering of services, and establishing and then managing the follow-on communication session for the discovery function. The salutation manager is typically independent of the processor operating system and communication protocol. The actual data transfer is under host control via the protocol stack constructed for the data type.

The BT salutation manager has a subordinate security manager, which is invoked when discovery is initiated. The security manager holds service and device security databases. It consults these databases when a request comes in for services. It also submits identifying information when a request for services goes out to another BT device.

The process of service discovery occurs as follows. client device either attempts to browse another device's server for information, or it requests information about the server. It does this by providing a unique universal identification code. The queried device responds, depending on the security manager's decision, which is based on the device information in its database. If the device is a trusted unit according to the database, the requested information will be returned.

Although BT was originally designed as a replacement for wired connections between devices, it has evolved into a major radio interface candidate for personal area networking and proximity area networking. This is due at least in part to its low power consumption.

As can be appreciated, the data packet routing protocol is a key technology to realize multi-hop packet forwarding within a BT Personal Area Network (PAN).

The inventor has observed that the BT PAN is a low bandwidth (about 15 kbytes/s in 6 hops), high latency (round trip time is about 100 ms to 300 ms in 6 hops) network. These observations come at least from an experiment depicted in FIG. 5.

The inventor has conducted an experiment that is depicted in FIG. 5. Eight BT nodes (N1-N8) were arranged to form a PAN within a room 100. A BT PAN between eight Bluetooth nodes was formed. In the BT PAN, Ad-hoc On-demand Distance Vector (AODV) was used as the routing protocol. The position of the nodes in this experiment were configured as follows: location A was on a conference table, location C was about 10 meters away from the conference table, and location E was about 20 meters away from the table. Initially, an active session passed through node 1, shown at location A. Then, node 1 was slowly moved from location A to location C. Node 1 was then retained at location C for some period of time. Subsequently, node 1 was then slowly moved from location C to location E. The temporal movement pattern is shown in the upper part of FIG. 6. During the experiment, a ping (ICMP echo) packet was continuously sent between two end nodes of an active session to monitor the change of topology. In FIG. 6, the link delay is plotted versus time. In this experiment, it was observed that the delay value remains stable for a period of time when the node N1 begins to move from location A to location C, and then suddenly increases sharply to a large value (greater than 1500 ms) when node N1 approaches location C. When the node N1 resides at location C the delay remains above 1500 ms, and varies significantly. When the node N1 moves from location C to location E, the delay first increases sharply, and then the ping packet fails to come back at the sender, although the link remained active.

What is apparent from this experiment is that unpredictable radio conditions may result in a serious QoS degradation. That is, although the physical (PHY) link is active, the link quality is sometimes too poor for any meaningful communication to occur.

As should be apparent to those skilled in the art, under such conditions the conventional best effort routing algorithms, that simply use the number of hops as the routing metric, cannot guarantee that a meaningful communication will occur.

As used herein, a link having an extremely large delay is referred to as an “unstable link.” Also, as used herein, a broken link may be referred to as an “imaginary link” if it is not detected as being broken by either a master or a slave. These two problems are caused by unpredictable in-door radio propagation. Regarding the unstable link condition, this typically occurs when both receivers are close to the boundary of each other's radio coverage, and the link quality is highly influenced by multi-path radio propagation. In such a situation, high packet error rate causes frequent packet retransmission. This typically results in difficultly receiving every packet in a timely manner. In such a situation, the bandwidth of the link becomes very low, while the delay of the link becomes very high. Regarding the imaginary link, nodes are already out of the communication range, but the MAC layer still assumes that the link is active. According to the BT specification, the master node does not continuously monitor the existence of slave nodes, the only restriction is that the master node should poll a slave node once within a fixed period of time. The fixed period of time is determined by the LinkSupervisionTimeout parameter. If for any reason no baseband packets are received from a link for a duration longer than the fixed period of time, the connection is disconnected. In other words, a lost link cannot be detected within the fixed period of time. The value for the fixed period of time can be adjusted through the Bluetooth link layer parameter LinkSupervisionTimeout. The default value is 20 seconds, during which time the imaginary links is essentially undetectable.

Research is underway regarding ad hoc routing and a QoS extension to ad hoc routing to solve the problem of determining a route in a network whose topology changes frequently. For example, one approach is known as Ad-hoc On-demand Distance Vector (AODV) routing (see, for example, Mobile Ad Hoc Networking Working Group, Internet Draft, 22 Apr. 2000, “Ad Hoc On-Demand Distance Vector (AODV) Routing”, Charles E. Perkins et al.). The format for the QoS extension has been suggested in: Mobile Ad Hoc Networking Working Group, Internet Draft, 14 Jul. 2000, “Quality of Service for Ad Hoc On-Demand Distance Vector Routing”, Charles E. Perkins et al. The basic concept of AODV is that the originator of a conversation broadcasts a Route Request (RREQ) message to search for its destination; and the node that knows the route to that destination replies to the RREQ message with a Route Reply message. The originator then selects one route for packet forwarding based on the received reply or replies.

More specifically, AODV builds routes using a route request/route reply query cycle. When a source node desires a route to a destination for which it does not already have a route, it broadcasts a route request (RREQ) packet across the network. Nodes receiving this packet update their information for the source node and set up backwards pointers to the source node in the route tables. In addition to the source node's IP address, current sequence number, and broadcast ID, the RREQ also contains the most recent sequence number for the destination of which the source node is aware. A node receiving the RREQ may send a route reply (RREP) if it is either the destination or if it has a route to the destination with corresponding sequence number greater than or equal to that contained in the RREQ. If this is the case, it unicasts a RREP back to the source. Otherwise, it rebroadcasts the RREQ. Nodes keep track of the RREQ's source IP address and broadcast ID. If they receive a RREQ which they have already processed, they discard the RREQ and do not forward it.

As the RREP propagates back to the source, nodes set up forward pointers to the destination. Once the source node receives the RREP, it may begin to forward data packets to the destination. If the source later receives a RREP containing a greater sequence number or contains the same sequence number with a smaller hopcount, it may update its routing information for that destination and begin using the better route.

As long as the route remains active, it will continue to be maintained. A route is considered active as long as there are data packets periodically traveling from the source to the destination along that path. Once the source stops sending data packets, the links will time out and eventually be deleted from the intermediate node routing tables. If a link break occurs while the route is active, the node upstream of the break propagates a route error (RERR) message to the source node to inform it of the now unreachable destination(s). After receiving the RERR, if the source node still desires the route, it can reinitiate route discovery.

AODV maintains routes for as long as the route is active. This includes maintaining a multicast tree for the life of the multicast group. Because the network nodes are mobile, it is likely that many link breakages along a route will occur during the lifetime of that route.

The above-noted QoS-related extensions proposed by Perkins et al. include a routing table extension corresponding to each destination of Maximum Delay, Minimum Available Bandwidth, List of Source Requesting Delay Guarantees, and List of Sources Requesting Bandwidth Guarantees.

Proposals have also been made with regard to PAN routing. However, these proposals do not consider the QoS, or how to utilize link layer information for route optimization.

BT 1.1 provides several methods to monitor/adjust the link layer performance. The above-mentioned LinkSupervisionTimeout parameter provides a quality metric of the link between a master and a slave. The LinkSupervisionTimeout parameter is used by the master or slave BT device to monitor link loss. If for any reason no baseband packets are received from that link for a period of time greater than the time specified by the LinkSupervisionTimeout value, the link is considered to be broken, and the connection is disconnected. In other words, a link that is lost cannot be detected within the fixed period of time. The value for the fixed period of time can be adjusted through Bluetooth Host Controller Interface (HCI) commands, and the default value is 20 seconds.

A Received Signal Strength Indication (RSSI) is a metric that reflects the relative signal strength of an active link. As currently specified, a command reads a value for the difference between the measured RSSI and the limits of a “Golden Receive Power Range” for a connection handle to another BT device. The RSSI metric is a read-only parameter in the Bluetooth baseband.

One important issue in the ad hoc routing protocol is how to maintain/adjust the route after a change in link status. In a best-effort routing protocol, an intermediate node generates a Route Error (RERR) message to the source node, which then triggers a re-route process. In QoS routing, however, this process becomes more involved. In principle, the route should be adjusted when the end-to-end path delay is larger than a negotiated threshold delay. An intermediate node should report any “serious” link QoS degradation to the originator of the session. In practice, however, it is difficult to decide whether the change of link status should be reported, because the seriousness depends on the status of all links along the path, and the decision regarding the seriousness of degradation cannot be made by an intermediate node equipped only with local information. For example, if the negotiated path delay is 200 ms, and the current path delay is 180 ms, the intermediate node should report the link status change when the link delay is increased from 50 ms to 80 ms (making the current path delay 210 ms and a QoS violation), but should ignore the change when the link delay is increased from 50 ms to 60 ms (making the current path delay 190 ms).

An end-to-end traffic approach is known in the art. In this approach, an end node periodically broadcasts a probe packet to measure the delay. If the delay is larger than the negotiated threshold (QoS violation), the re-route process is triggered, and a RREQ packet is generated to find a new path.

Another important issue is the utilization of a route cache, which means that the intermediate node replies to the route request based on its current routing table information. For example, and referring to FIG. 2, assume that there is a route from node 1 to 4, via intermediate node 2, and that node 5 broadcasts a RREQ to search the route to node 1. In this case the intermediate node 2 will reply to a RREQ from node 5 based on its current information, (i.e., based on its current routing table information). However, it is difficult to maintain a QoS route cache (e.g., node 2 to 4, 100 kbps) for such a cache reply, because the path properties (e.g., bandwidth of path 2-4 is 100 kbps) depends on the status in other nodes, and may vary frequently. For example, when the load at node 3 varies from 100 kps to 50 kbps, the path bandwidth (path 2-4) also needs to be updated to 50 bps because node 3 is the bottleneck of the link. The conventional approach is that the node with the active QoS session broadcasts the QoS changes to relevant nodes (e.g. node 3 broadcasts its change to 2 and 4). As discussed above, it is difficult to make a decision whether to update this information. Furthermore, the above noted end-to-end measurement approach cannot update the information in the intermediate node, as it only logs the timestamp at the end node.

As a result, the current QoS update broadcasting approach cannot guarantee the precision of the update, and may waste the bandwidth resource. Furthermore, the current end-to-end measurement approach cannot update the route cache in an intermediate node.

None of the prior art discussed above provides a totally satisfactory solution to the problems of operating a BT network in an environment where RF propagation conditions vary widely, especially due to the movement of mobile nodes.

### SUMMARY OF THE PREFERRED EMBODIMENTS

The foregoing and other problems are overcome, and other advantages are realized, in accordance with the presently preferred embodiments of these teachings.

This invention grows out of an appreciation by the inventor that the QoS is an important metric for a BT PAN, as unpredictable indoor radio conditions can degrade the QoS and the stability of the routing protocol that is used to guarantee the QoS. In a first aspect this invention provides a traffic measurement embodiment that updates the QoS information in all nodes along the path of a packet. This embodiment functions to monitor the end-to-end QoS quality, and improves the protocol stability. In a second aspect this invention provides a cross-layer optimization embodiment by which the BT Link layer information (e.g., LinkSupervision_Timeout and RSSI) is integrated into the PAN routing protocol, to further enhance the stability of the routing protocol.

The traffic measurement embodiment that is used for QoS monitoring improves the efficiency and the precision of the QoS route update, while the traffic measurement and cross-layer optimization (including LinkSupervisionTimeout and RSSI) embodiments together function to improve the stability and feedback speed of the PAN routing protocol.

This invention provides a routing method, as well as a wireless network system and a mobile device that operate in accordance with the method. In accordance with the method for operating a wireless network comprised of end nodes and at least one intermediate node, the method operates such that, at an originating node of a session with a destination node, initiating a route search by sending a Route Request message; at the destination node, or another node having knowledge of the destination node, replying to the originating node with a Route Reply message when there is a valid route, where route delay information relative to the responding node is contained within the Route Reply message; and selecting a route with a smallest route delay to send a packet from the originating node to the destination node. If either one of the originating node or the destination node detect a violation of path Quality of Service, the method further initiates a re-route search. More specifically, if either one of the originating node or the destination node detect that the route delay exceeds a threshold route delay value, the method further initiates the re-route search.

An intermediate node determines the route delay between itself and the destination node by receiving a probe message sent by the originating node to the destination node; recording a time of arrival of the probe message; forwarding the probe message towards the destination node; receiving a response to the probe message from the destination node; recording a time of arrival of the response to the probe message and calculating the round trip path delay between itself and the destination node by subtracting the recorded time of arrival of the probe message from the recorded time of arrival of the response to the probe message. The round trip path delay is stored in at least a link table and a routing table of the intermediate node. The method may further periodically determine a received signal strength indication of the links at all nodes along the path and, if the determined received signal strength indication of one link is below a threshold value, the method adjusts the round trip path delay of the path that contains that link at the node that determines the link degradation. The change of route delay in one node is propagated to all nodes along the path by the traffic measurement approach discussed above. More specifically, if the determined received signal strength indication is below the threshold value, the method operates by increasing the link delay and stored round trip path delay value in the routing table for the node that determines this change. This link status change is updated to all route entries that contains that link at all nodes along the path by traffic measurement. The method may further decrease a LinkSupervisionTimeout parameter of the BT Baseband in the intermediate node in order to increase the speed of detection of a link break condition. In response to detecting the link break condition, the method sends a Route Error message to the originating node to cause the originating node to trigger a re-route operation.

In the preferred embodiment the network operates in accordance with an ad hoc routing protocol, such as the Ad Hoc On-Demand Distance Vector (AODV) routing protocol.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a representation of a prior art BT protocol stack;

FIG. 2 is an example of routes in a PAN, where the routes have different delay values;

FIG. 3 is a graphical depiction of a traffic measurement technique in accordance with an aspect of this invention, where intermediate nodes are responsive to echo_request and echo_reply messages that pass through them for time stamping the round trip time between themselves and a destination node of the source node that originated the echo_request message;

FIG. 4 is a logic flow diagram that illustrates the operation of the PAN when integrating RSSI and LinkSupervisionTimeout with a traffic measurement to guarantee the stability of the routing protocol and the QoS;

FIG. 5 illustrates an experimental network layout;

FIG. 6 illustrates exemplary durations of time that a mobile node shown in FIG. 5 dwells at different locations, and the corresponding link delays;

FIG. 7 is a simplified block diagram of a mobile node that is suitable for functioning as a node in the PAN; and

FIG. 8 is a diagram showing the operation of exemplary end and intermediate nodes (a-e) when updating their respective link (L) and routing (R) tables, in response to a detected link degradation, in accordance with an aspect of this invention.

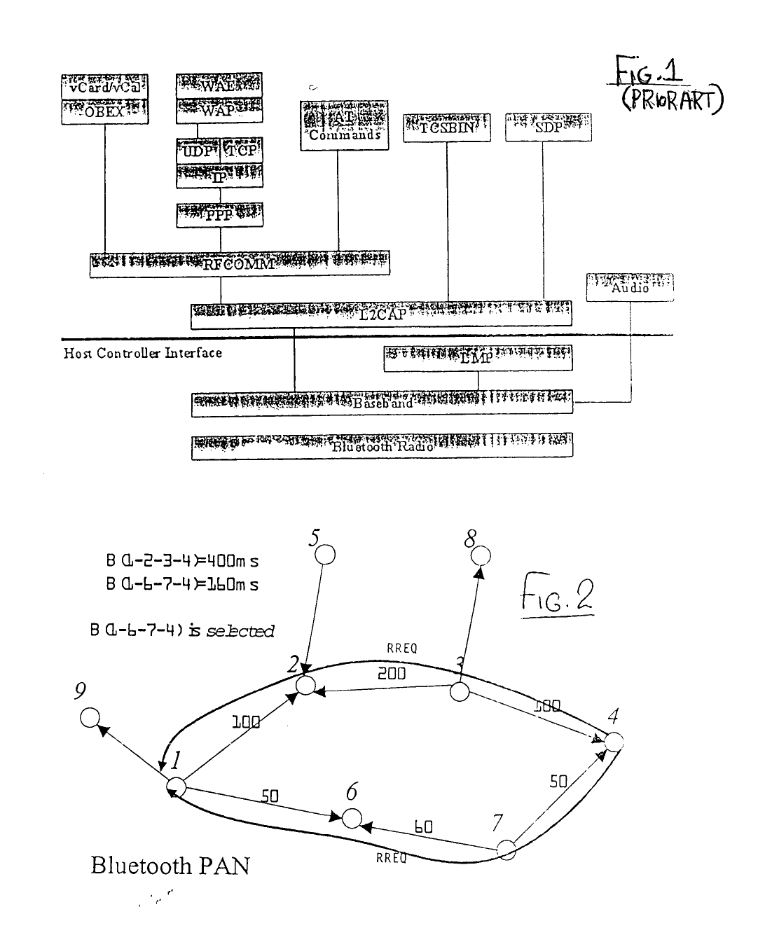

### DETAILED DESCRIPTION OF THE PREFERRED EMBODIMENTS

The invention is first discussed in the context of ad-hoc on-demand routing with a delay extension. In a manner that differs significantly from conventional routing protocols, the invention utilizes the path delay as the metric for the route search. As a result, the path with the smallest delay is used for communication. In a presently preferred AODV embodiment of this invention, the originator of the session begins the route search process by broadcasting a RREQ (Route Request) message, and the destination (or any nodes who know the destination) reply to the originator with a RREP message when there is a valid route. The delay information is also provided to the originator in the RREP message. The originator then selects a route with smallest delay value to forward the packet. If the originator/destination detects a violation of path QoS, it triggers the re-route search. In the example of FIG. 2 that was discussed above, the route (1-6-7-4) is selected because it has the minimum delay value (160 ms versus 400 ms).

To overcome the deficiencies in the prior art QoS and end-to-end routing approaches, this invention provides a novel end-to-end update approach that is used to update the QoS information in a timely manner at both the end nodes (originator and destination), as well as at intermediate nodes. A probe packet is forwarded periodically to monitor/update the change of QoS status. When an end node detects that the route delay is larger than the negotiated threshold value, it re-triggers the route search to locate a better route.

Discussing now multi-hop traffic measurement, it is first noted that the conventional end-to-end measurement can only measure the delay between two end nodes by comparing the timestamp when the request packet is forwarded, and when the reply is received. In accordance with an aspect of this invention, all intermediate nodes also operate to update their respective routing information based on the assumption that the forward path (source to destination) and the reverse path (destination to source) are the same path. This can be guaranteed by designing the routing protocol to remove uni-direction paths.

In accordance with this aspect of the invention, the source node generates an echo_request packet to its destination, and the destination node replies with an echo_reply message as soon as it receives echo_request, in a manner that is somewhat similar to the current ping. However, in the improved technique the intermediate node (e.g., node 2 in FIG. 2) records the time when the echo_request was received from the source node (e.g., node 1 in FIG. 2), and when the same echo_reply was received from the destination node (e.g., node 4 in FIG. 2). The difference between the two recorded times is thus a timestamp of the round trip time (RTT) from the intermediate node to the destination node.

Referring to the example shown in FIG. 3, node A sends an echo_request to node E, and node E replies to the echo_request with an echo_reply. The RTT between an intermediate node, e.g., the RTT_{b} of intermediate node B, is calculated as the difference between the two timestamps Tb1 (when the echo_request is received from node A) and Tb2 (when the echo-reply is received from node E). The intermediate nodes C and D operate in a similar manner to computer their respective RTTs from their respective timestamps.

Discussing now the inter-layer optimization aspects of this invention, the traffic measurement approach discussed above is based on the assumption of a timely forwarding of the probe packet. However, when the link status becomes unstable, as in the unstable link and imaginary link conditions discussed above, the probe packet cannot be guaranteed to be forwarded in a timely manner to update the delay information in the link tables and routing tables of the various nodes. As a result, the re-route action cannot be triggered in a timely manner.

The inventor has noticed that a link can be lost more readily when the LinkSupervisionTimeout parameter has a small value, as compared with enhanced link stability when the LinkSupervisionTimeout value is large. Conversely, the throughput between a master node and its slave node is smaller when the LinkSupervisionTimeout value is large. If the LinkSupervisionTimeout is set to a value smaller than the polling interval, the link is lost even though its link quality is very good.

Based on this observation, the inventor has realized that it is advantageous to integrate the BT protocol RSSI and LinkSupervisionTimeout parameters into the routing protocol. That is, when it is desired to reflect the change of the link metric at each node in the path caused by unpredictable radio propagation conditions, the use of the RSSI can be employed in the routing protocol. To this end, the RSSI is measured periodically. When the RSSI is smaller than a predefined threshold value, the following actions are triggered.

First, the delay value in the corresponding link table and routing table entries are increased. For example, and referring as well to FIG. 8, assume there is an active path (a->b->c->d->e), and that the RSSI of link c-d is found to be below the threshold (link degradation detected at time T1). First, the link entry of c-d in node c is updated to a larger value at T2, such as from the value of 10 to the value of 20, then the cost metric for those route entries that use the affected link are also modified. For example, the cost metric of c-d, c-e in node c is updated to a larger value based on the new link metric of link c-d. This information is unicast to the source node (T3). At T4, all the nodes on the route then update their routing table to reflect the bad (degraded) link quality on that route. For example, the routing table in node b is also updated after receiving the update message. At node b, a routing table entry to c, d and e is adjusted to a large value.

The re-route action is triggered only when the route bandwidth in the end-host's routing table is smaller than the threshold, when the link degradation occurs between an intermediate node and the end host. However, when the link degradation occurs between two intermediate nodes, this change may not be propagated to the end host because of unstable link status. Sometimes, the unstable link status may result in the failure of propagation of control messages such as a route maintenance packet. Thus, a dynamic LinkSupervisionTimeout adjustment is used to trigger a link break faster when the link degradation is so serious that a control message cannot be reliably propagated. This means that whenever the RSSI is smaller than the threshold, the LinkSupervisionTimeout is also preferably reduced. If the control message cannot be propagated in a timely fashion, a link break is triggered. This link break is soon reported to an end host by the current AODV route maintenance mechanism, and finally leads to the re-route search at the end host. The amount of adjustment to the LinkSupervisionTimeout and link delay depends on the application environment. Preferably, the update to the link delay occurs with twice the original value, and the LinkSupervisionTimeout with half of the original value. Generally, larger amounts of adjustment result in a faster response speed.

Because the re-route action is triggered based on the information stored within an end node, the re-route action begins only when the route delay in its local routing table increases. In other words, when the QoS degradation occurs between an end node and its neighbor, the re-route operation is triggered due to the increase in the route delay. But when neither end of the link is an end node, the increase of route delay only updates the routing table information in an intermediate node, and may not be propagated to the end node on time because of an unstable link status. In this situation, the decrease of LinkSupervisionTimeout finally triggers the link break in the intermediate node. In response, the intermediate node propagates a Route Error message (RERR) to the end node according to the AODV specification that in turn causes the end node to trigger the re-route process.

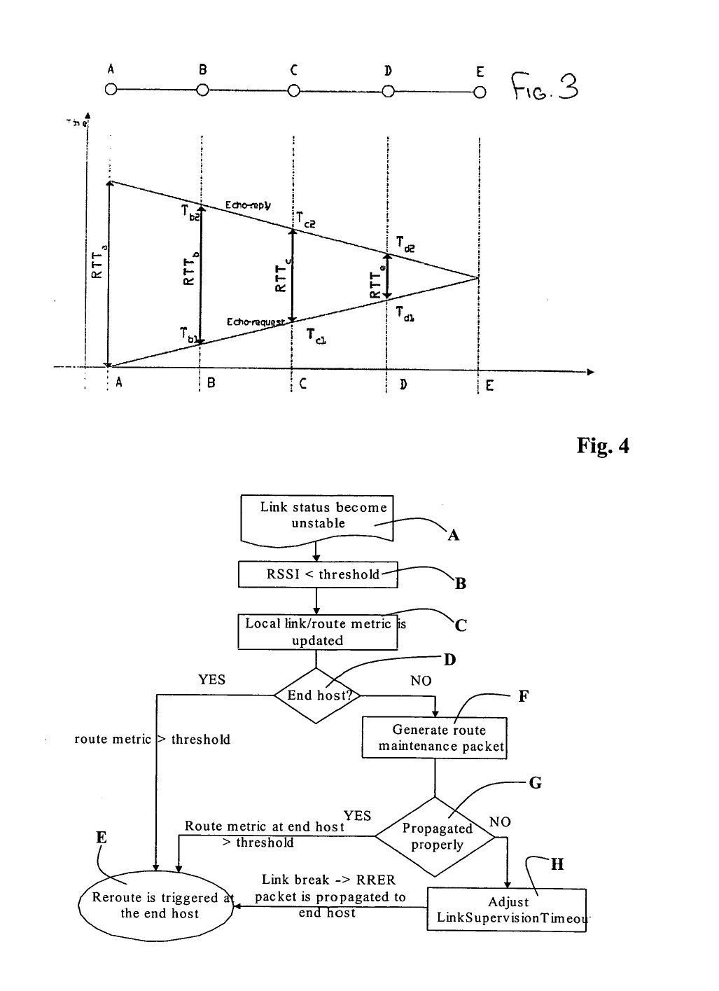

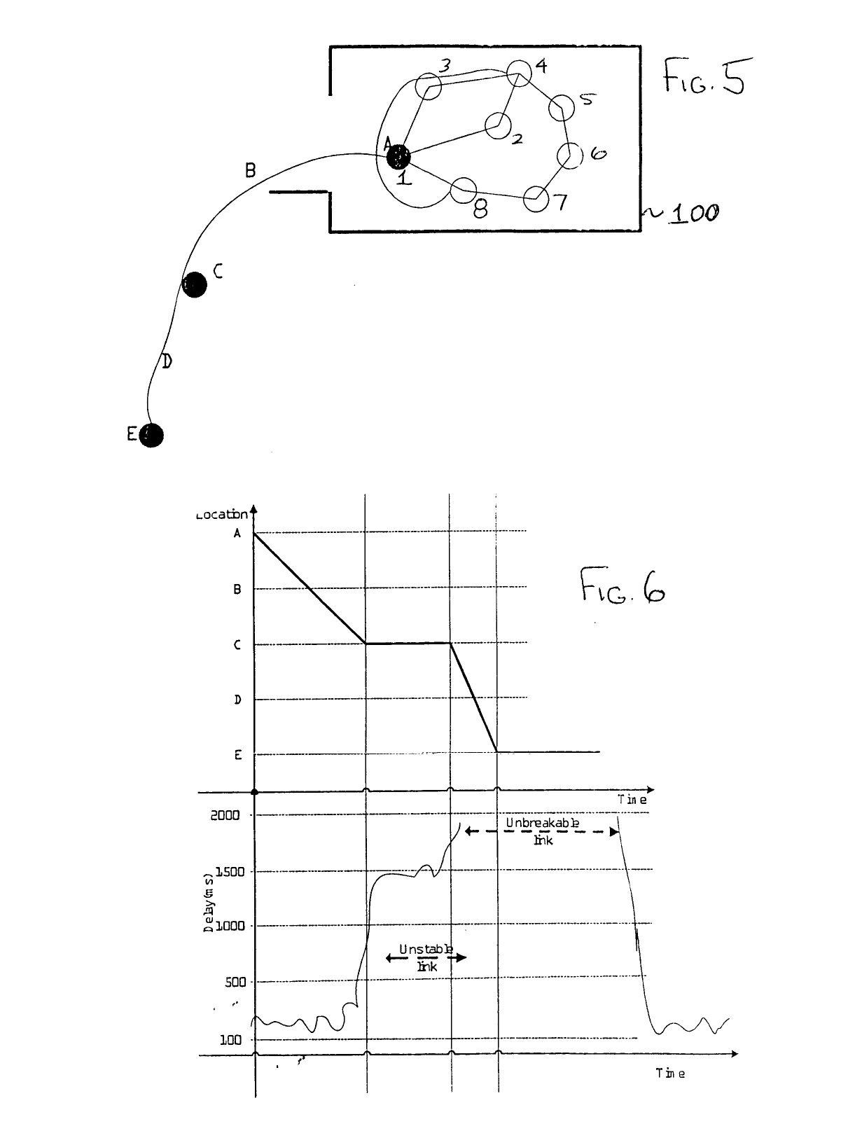

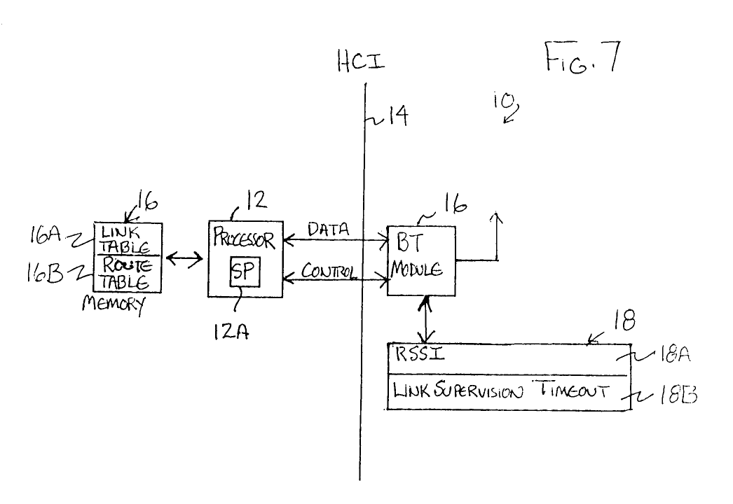

Relationships between the route maintenance, RSSI and LinkSupervisionTimeout are shown in FIG. 4. When the link instability is detected (Block A), and the RSSI is below the threshold, as shown in block B, the local link and routing table information is updated, in block C. Preferably, the local link is increased by 100%. A determination is made at block D, that when one end of the link is an end host, a route search is triggered (shown in block E). If both ends of the link are an intermediate node, a route maintenance packet is generated (shown in block F). In this case, information may not be propagated to the end host on time. When a determination is made that route maintenance information is propagated properly, as shown in block G, the end host starts a route search after receiving this information. If the link is unstable for sending a control message, such as the route maintenance, a link break is triggered by the decrease of the LinkSupervion Timeout value. In this case, it is preferable to decrease the LinkSupervisionTimeout by, for example, 50%. This step of adjusting the LinkSupervisionTimeout is shown in block H. This adjustment results in a route search at the end host. The integration of these methods assures the stability of the routing protocol.

The traffic measurement helps to guarantee the QoS link when the link condition is normal. When the link condition is unstable, the QoS of the route is guaranteed by the RSSI and the LinkSupervisionTimeout adjustments. As a result, by integrating the traffic measurement, RSSI, and LinkSupervisionTimeout approaches, the QoS route can be guaranteed in the BT PAN under typical field operating conditions.

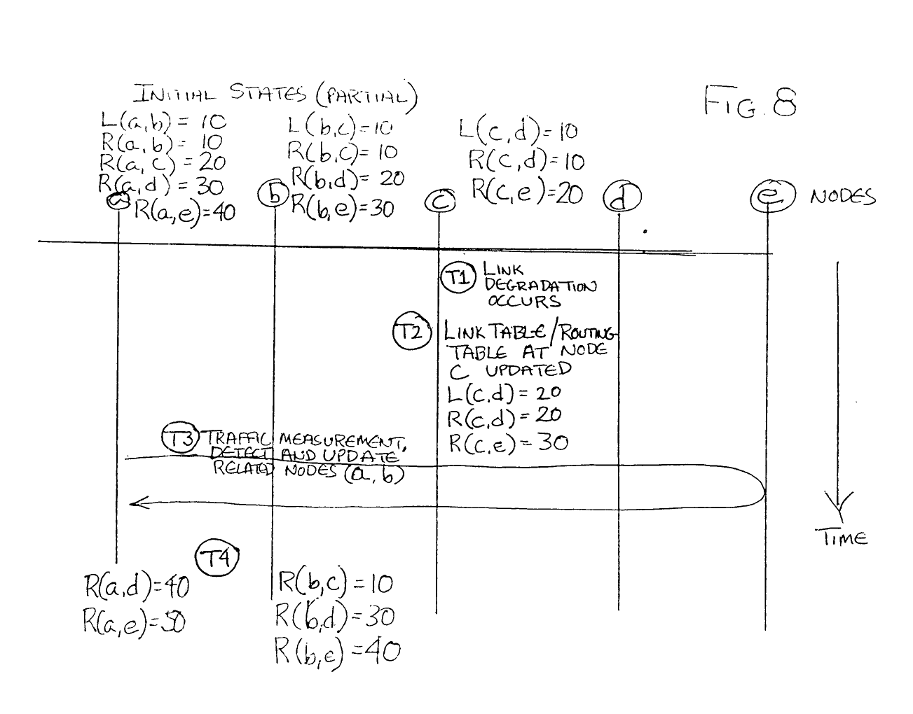

Based on the foregoing description, it can be appreciated that this invention also pertains to a computer program that operates a network data processor, such as a data processor located in a mobile network node, such as a cellular telephone, or in a fixed network node, for executing all or some of the various aspects of the routing method described above. For example, FIG. 7 is a simplified block diagram of a mobile node 10 that is suitable for functioning as a node in the PAN. The mobile node may be implemented as a mobile device such as a cellular telephone or a personal communicator, and includes a data processor 12 that operates with a stored program (SP) 12A, and a memory 16 wherein are stored the link table 16A and routing table 16B, along with other data necessary for the operation of the mobile device in the PAN. The RSSI and LinkSupervisionTimeout values 18A and 18B, respectively, are stored in a memory 18 of a BT module 16 and accessible by the data processor 12 through the Host Controller Interface (HCI) 14.

The foregoing description has provided by way of exemplary and non-limiting examples a full and informative description of the best method and apparatus presently contemplated by the inventor for carrying out the invention. However, various modifications and adaptations may become apparent to those skilled in the relevant arts in view of the foregoing description, when read in conjunction with the accompanying drawings and the appended claims. As but some examples, the teachings of this invention may be adapted to other wireless routing protocols than the AODV technique, and it can furthermore be adapted for use with wireless protocols other than BT. However, all such and similar modifications of the teachings of this invention will still fall within the scope of this invention. Further, while the method and apparatus described herein are provided with a certain degree of specificity, the present invention could be implemented with either greater or lesser specificity, depending on the needs of the user. Further, some of the features of the present invention could be used to advantage without the corresponding use of other features. As such, the foregoing description should be considered as merely illustrative of the principles of the present invention, and not in limitation thereof, as this invention is defined by the claims which follow.

What is claimed is:

1. A method for operating a wireless network comprised of end nodes and at least one intermediate node, comprising:
at an originating node of a session with a destination node, initiating a route search by sending a Route Request message;
at the destination node, or another node having knowledge of the destination node, replying to the originating node with a Route Reply message when there is a valid route, where route delay information relative to the responding node is contained within the Route Reply message; and
selecting a route with a smallest route delay to send a packet from the originating node to the destination node.

2. A method as in claim 1, where if either one of the originating node or the destination node detect a violation of path Quality of Service, further comprising initiating a re-route search.

3. A method as in claim 1, where if either one of the originating node or the destination node detect that the route delay exceeds a threshold route delay value, further comprising initiating a re-route search.

4. A method as in claim 1, where an intermediate node determines the route delay between itself and the destination node by:
receiving a probe message sent by the originating node to the destination node;
recording a time of arrival of the probe message;
forwarding the probe message towards the destination node;
receiving a response to the probe message from the destination node;
recording a time of arrival of the response to the probe message; and
calculating the round trip path delay between itself and the destination node by subtracting the recorded time of arrival of the probe message from the recorded time of arrival of the response to the probe message.

5. A method as in claim 4, further comprising storing the round trip path delay in at least a link table and a routing table of the intermediate node.

6. A method as in claim 4, further comprising:
periodically determining a received signal strength indication at the intermediate node; and
if the determined received signal strength indication is below a threshold value, adjusting the calculated round trip path delay value.

7. A method as in claim 5, further comprising:
periodically determining a received signal strength indication at the intermediate node; and
if the determined received signal strength indication is below a threshold value that indicates a degraded link, increasing the link delay and stored round trip path delay value in the node that detects that the signal strength is below the threshold value, and updating a routing table for all nodes that contain a route entry that comprise the degraded link.

8. A method as in claim 7, further comprising decreasing a link timeout value in the intermediate node in order to increase the speed of detection of a link break condition.

9. A method as in claim 8, further comprising, in response to detecting the link break condition, sending a Route Error message to the originating node to cause the originating node to trigger a re-route operation.

10. A method as in claim 1, where the network operates in accordance with an ad hoc routing protocol.

11. A method as in claim 1, where the network operates in accordance with an Ad Hoc On-Demand Distance Vector (AODV) routing protocol.

12. A wireless network comprised of end nodes and at least one intermediate node, comprising in said nodes programmed data processors for implementing a routing protocol, where for at an originating node of a session with a destination node, said data processor initiates a route search by sending a Route Request message; where in a destination node, or another node having knowledge of said destination node, a data processor replies to said originating node with a Route Reply message when there is a valid route, where route delay information relative to said responding node is contained within said Route Reply message; and where said data processor in said originating node selects a route with a smallest route delay to send a packet to said destination node.

13. A wireless network as in claim 12, where if either one of said originating node or said destination node detect a violation of path Quality of Service, the respective data processor initiates a re-route search.

14. A wireless network as in claim 12, where if either one of said originating node or said destination node detect that said route delay exceeds a threshold route delay value, the respective data processor initiates a re-route search.

15. A wireless network as in claim 12, where a data processor of an intermediate node determines said route delay between itself and said destination node by receiving a probe message sent by said originating node to said destination node; recording a time of arrival of said probe message; forwarding said probe message towards said destination node; receiving a response to said probe message from said destination node; recording a time of arrival of said response to said probe message; and calculating said round trip path delay between itself and said destination node by subtracting said recorded time of arrival of said probe message from said recorded time of arrival of said response to said probe message.

16. A wireless network as in claim 15, where said data processor of said intermediate node further stores said round trip path delay in at least a link table and a routing table of said intermediate node.

17. A wireless network as in claim 15, where said data processor of said intermediate node further periodically determines a received signal strength indication at said intermediate node and, if said determined received signal strength indication is below a threshold value, adjusts said calculated round trip path delay value.

18. A wireless network as in claim 16, where said data processor of said intermediate node further periodically determines a received signal strength indication at the intermediate node, and if the determined received signal strength indication is below a threshold value that indicates a degraded link, increases the link delay and stored round trip path delay value in the node that detects that the signal strength is below the threshold value, and thereafter initiates an update of the routing table for all nodes that contain a route entry that comprise the degraded link.

19. A wireless network as in claim 18, where said data processor of said intermediate node further decreases a link timeout value in said intermediate node in order to increase the speed of detection of a link break condition.

20. A wireless network as in claim 19, where said data processor of said intermediate node, in response to detecting said link break condition, sends a Route Error message to said originating node to cause said originating node to trigger a re-route operation.

21. A wireless network as in claim 12, where said network operates in accordance with an ad hoc routing protocol.

22. A wireless network as in claim 12, where said network operates in accordance with an Ad Hoc On-Demand Distance Vector (AODV) routing protocol.

23. A mobile node comprising a programmed data processor for causing said mobile node to function as an intermediate node between two end nodes in a wireless network, said data processor operable to determine a route delay between the mobile node and a first end node by receiving a probe message sent by a second end node to said first end node; said data processor being further operable for recording a time of arrival of said probe message; for forwarding said probe message towards said first end node; for receiving a response to said probe message from said first end node; for recording a time of arrival of said response to said probe message; and for calculating a path delay between itself and said first node by subtracting said recorded time of arrival of said probe message from said recorded time of arrival of said response to said probe message.

24. A mobile node as in claim 23, where said data processor further stores said calculated path delay in at least a link table and a routing table.

25. A mobile node as in claim 23, where said data processor further periodically determines a received signal strength indication and, if said determined received signal strength indication is below a threshold value, adjusts said calculated path delay value.

26. A mobile node as in claim 24, where said data processor further periodically determines a received signal strength indication at the intermediate node, and if the determined received signal strength indication is below a threshold value that indicates a degraded link, increases the link delay and stored round trip path delay value in the node that detects that the signal strength is below the threshold value, and thereafter initiates an update of the routing table for all nodes that contain a route entry that comprise the degraded link.

27. A mobile node as in claim 26, where said data processor further decreases a link timeout value in order to increase the speed of detection of a link break condition.

28. A mobile node as in claim 27, where said data processor, in response to detecting said link break condition, sends a Route Error message to said second node to initiate a re-route operation.

29. A mobile node as in claim 23, where said wireless network operates in accordance with an ad hoc routing protocol.

30. A mobile node as in claim 23, where said wireless network operates in accordance with an Ad Hoc On-Demand Distance Vector (AODV) routing protocol.
